(19) United States
(12) Patent Application Publication
(10) Pub. No.: US 2017/0138576 A1
(43) Pub. Date: May 18, 2017

(54) RECESSED LIGHTING ASSEMBLY

(71) Applicant: DMF, Inc., Carson, CA (US)

(72) Inventors: Eric Peng, Long Beach, CA (US); Michael D. Danesh, Beverly Hills, CA (US)

(21) Appl. No.: 14/942,937

(22) Filed: Nov. 16, 2015

(51) Int. Cl. F21V 23/00; F21V 17/18; F21S 8/02

(52) U.S. Cl. CPC F21V 23/001; F21S 8/02; F21V 17/18

(57) ABSTRACT

A fire-resistant, recessed lighting unit that obviates the need for a separate junction box and a separate incandescent “can”. Other embodiments are also described and claimed.

### FIELD

An embodiment of the invention relates to a recessed lighting assembly that has a fire resistant casing, a light source module that is held inside the casing, and a trim attached to the casing. Other embodiments are also described.

### BACKGROUND

Recessed lighting units are typically installed or mounted into an opening in a ceiling or a wall. Modern recessed lighting units generally consist of a trim, a light source module, a driver circuit, a legacy incandescent “can” in which the light source module and driver circuit are housed, a junction box, and a set of hangar bars to which a horizontally oriented frame or platform is directly attached. The can and junction box are attached to the horizontally oriented platform. The combination of the can and junction box attached to the horizontal platform is bulky and expensive to manufacture.

### SUMMARY

An embodiment of the invention is a recessed lighting unit that advantageously obviates the need for a separate junction box that is dedicated to the recessed lighting unit, because the building electrical power network wires, that supply power to another nearby recessed lighting unit or that come from a nearby shared wire enclosure or junction box, are routed directly into the casing of the recessed lighting unit (for supplying power to a light source module inside the casing.) A further advantageous aspect is that the light source module (to which a trim has been attached, e.g., via a twist and lock mechanism) is positioned deeper inside a casing of the recessed lighting unit, thereby yielding improvements in the illumination provided by the module. The casing has a closed top end, and a side wall having a top edge which joins the closed top end, wherein the side wall extends downward from the closed top end and is curved so as to completely surround a cavity that is between the closed top end and an open bottom end of the casing that is defined by a bottom edge of the sidewall. The trim may be composed of a crown that has a frusto-conical shape, wherein the crown has a base with a base opening formed therein, and a top with a top opening formed therein. Light to be emitted from the module is to pass through the crown by passing through the top opening and then through the base opening before illuminating a room. A frustum extends from the base of the crown to its top. The trim also has a brim that is attached to the base and encircles the base opening. The brim will sit flush against a ceiling or wall behind which the casing is installed, e.g., attached to structural beam member of the building. To attach the trim to the light source module, a means is used for attaching the top of the crown to the light source module. The module is held in its deeper position inside the casing, by a means that is anchored to the frustum of the crown and that is for attaching to the sidewall of the casing. The crown is dimensioned to be tall enough such that when the light source module is attached to the top of the crown, the light source module is held entirely within the cavity of the casing (when the means anchored to the frustum of the crown is attached to the sidewall of the casing.)

In one embodiment, a holding bracket is provided that can slide vertically within the cavity of the casing. The bracket has two or more arms that extend upward from a frame, where each arm has a slot formed lengthwise in it and through which an attaching member extends; the attaching member is fixed to the sidewall of the casing, so that the arms can slide up and down while being guided by the attaching member through the slot. The light source module is attached to the frame of the bracket. The light source module receives electrical power from the building electrical system through high voltage wires that go into the casing and connect to the module; the bracket prevents the light source module from hanging only by these high voltage wires, in the event that the mechanism for attaching the trim to the sidewall of the casing becomes accidentally overloaded (thereby causing the trim and the attached light source module to fall out of the casing, where the casing is mounted behind a ceiling, under the pull of gravity). Also, the bracket may be designed to be short enough, e.g., its arms are short enough, to ensure that in its lowest position, the attached light source module does not hang so far below the casing as to freely give a user access to the high voltage wires inside the casing; with the bracket in its lowest position, the user should have to first detach the light source module from the bracket before being able to disconnect or connect the high voltage wires.

The bracket may be free to slide vertically downward, until a stop is reached which prevents the bracket from falling out of the casing (under the pull of gravity). The bracket may also be free to slide vertically upward; this enables the light source module, which is attached to the bracket, to be vertically moved upward into any desired recessed position inside the casing, e.g., by a user grasping and pushing the trim (to which the light source module is also attached) upward in the vertical direction, until the upper surface of the brim (of the trim) abuts a lower surface of the ceiling (a stop is reached.) In this manner, the holding bracket also allows trims of different depth (height) to be attached to the same light source module, while still being able to be positioned all the way up and flush against the ceiling.

The design of the recessed lighting unit can also easily accommodate irregularity in the thickness of the ceiling of a building, where some portions have greater thickness than others. The light source module is attached to the trim, but is other wise free to be pushed deeper into the casing as needed to accommodate a thicker ceiling condition. The mechanism for attaching the trim to the sidewall of the casing may include friction clips that are anchored to the crown portion of the trim; the friction clips are sufficiently strong to stay fixed in position against the sidewall of the casing despite the added weight of the light source module. By also providing a fire resistant casing, the recessed lighting unit eliminates the added bulk and size of traditional recessed lighting units that have a separate outer enclosure or fire box around the incandescent can.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness and reducing the total number of figures, a given figure may be used to illustrate the features of more than one embodiment of the invention, and not all elements in the figure may be required for a given embodiment. In other words, there may be elements shown in a given figure that are optional, or unnecessary, for certain embodiments.

FIG. 1A shows a perspective view of a recessed lighting unit according to one embodiment.

FIG. 1B depicts part an illumination network in which several of the recessed light units are connected directly without the use of dedicated junction boxes.

FIG. 2 shows a side cross section view of the embodiment of FIG. 1A along the cut A-A′.

FIG. 3 shows a front cross section view of the embodiment of FIG. 1A along the cut B-B′.

FIG. 4 shows a perspective view of a light source module.

FIG. 5 shows a perspective looking into the cavity of the casing, through the opening.

FIG. 6 shows a perspective view of a holding bracket.

### DETAILED DESCRIPTION

Several embodiments of the invention with reference to the appended drawings are now explained. Whenever the shapes, relative positions and other aspects of the parts described in the embodiments are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

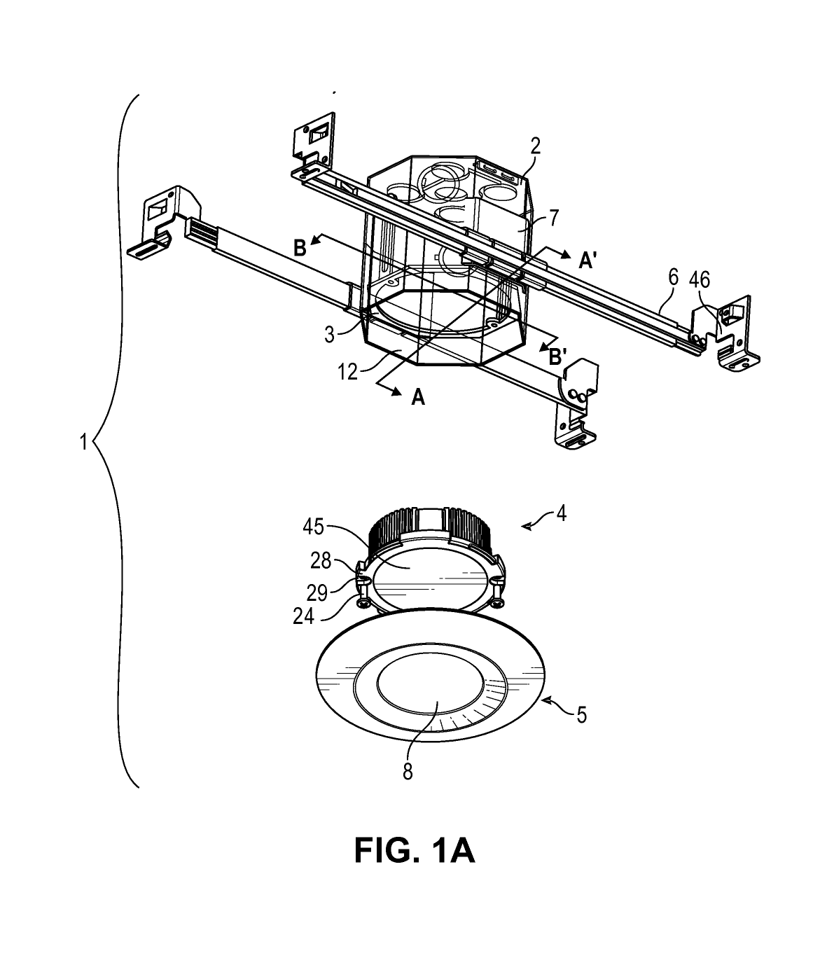

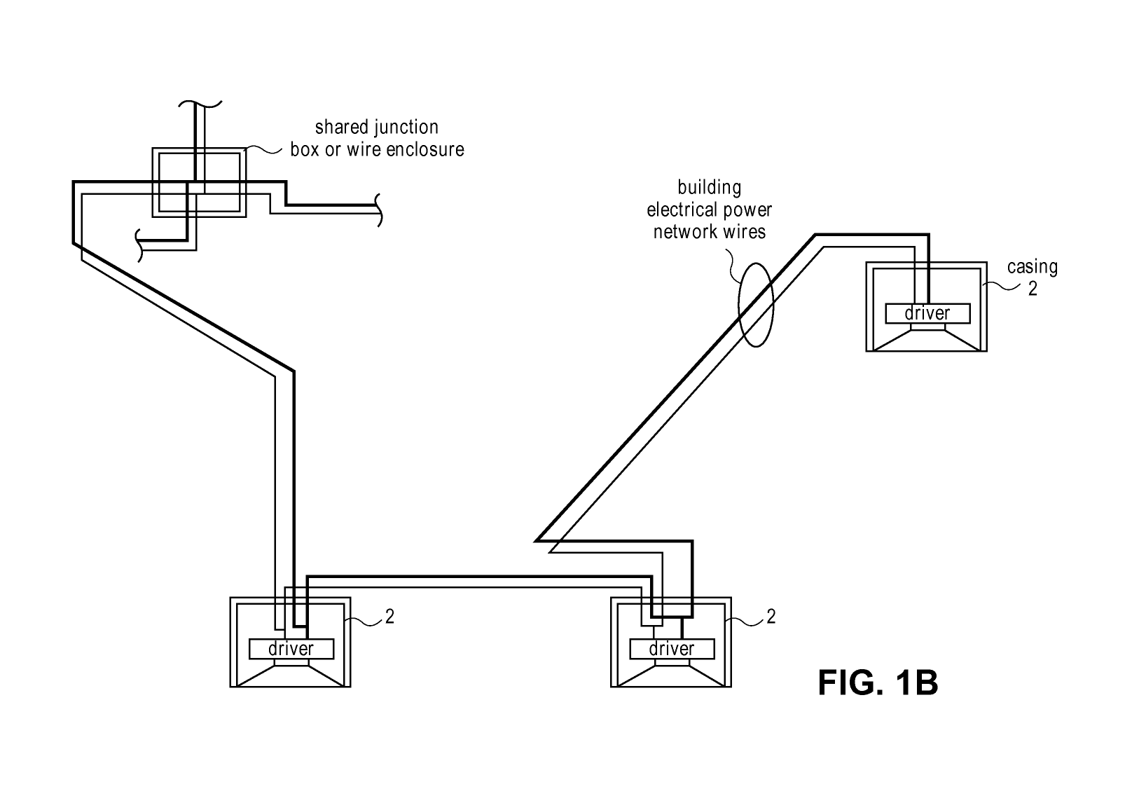

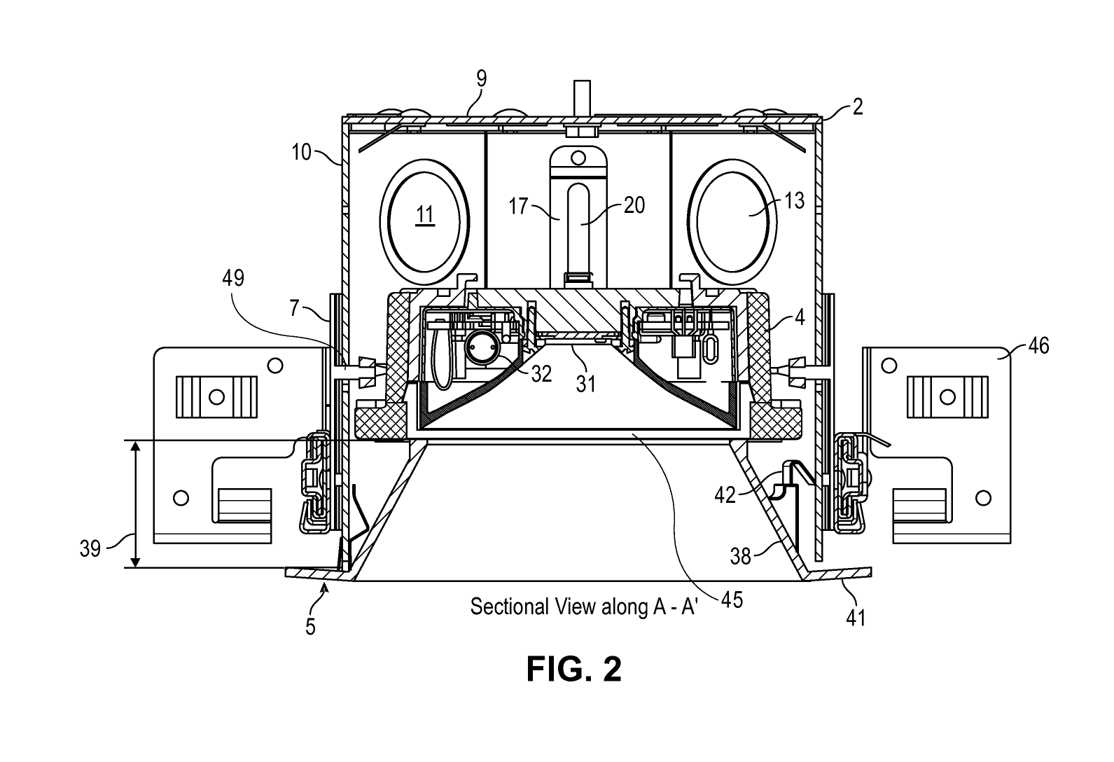

FIG. 1A shows a perspective view of an embodiment of a recessed lighting unit 1, which may be installed within a wall or a ceiling. The recessed lighting unit 1 may include a casing 2, a holding bracket 3 (which may also be referred as a yoke) inside the casing 2, a light source module 4 inside the casing 2, a trim 5, hangar bars 6, and casing holders 7. The recessed lighting unit 1 is positioned behind a ceiling or a wall so that the casing 2 is aligned with a hole in the ceiling or wall (not shown) through which the room is illuminated by the module 4. The light source module 4 as will be described below in more detail is contained inside the casing 2. The trim 5 serves the primary purpose of covering the exposed edge of the ceiling or wall where the recessed lighting unit 1 resides and where the hole is formed, while still allowing light from the light source module 4 to be emitted into a room through a trim opening 8. The trim 5 may also serve to hide the bottom edge of the casing 2 from view. In doing so, the trim 5 helps the recessed lighting unit 1 appear seamlessly integrated into the ceiling or wall. The trim 5 is attached to the light source module 4 (e.g., via a twist and lock mechanism, for example, or a snap fit mechanism), and also directly to the casing 2 (e.g. via friction clips, tension clips (tension grips), or magnets). The section views of the recessed lighting unit in FIG. 2 and FIG. 3 show the assembly with the trim 5 attached to the light source module 4, where a top of the crown 38 of the trim 5 is abutting the front surface of a lens 45, where the latter has been fitted into position covering the bottom opening of the housing of the module 4.

The casing 2 of the present invention is advantageous in that it is compact, cost-effective, and fire resistant. The casing 2 obviates the need for a traditional junction box attached to an incandescent “can,” which may be bulky and expensive. The casing 2 may be made of galvanized steel, injection molded plastic, or ceramic, which is also advantageous over the traditional, non-fire resistant incandescent can. The casing 2 may be fire-resistant in that it has a fire rating of up to two hours without any need for modification, where the fire rating is described in the National Electrical Code (NEC) and by the Underwriters Laboratories (UL) such as specified in UL 263 Standard for Fire Tests of Building Construction and Materials. The fixture may also be designed to attenuate airborne sound by the building partition (ceiling) in which it is installed; in one embodiment, the casing 2 can maintain a minimum Sound Transmission Class (STC) rating of 50; this alleviates the need for enclosing the casing 2 with any additional element in order to maintain a minimum 50 STC rating.

In one embodiment, as shown in the section view of FIG. 2, the casing 2 may have a closed top end 9, and a side wall 10 that surrounds a cavity 11 and defines a bottom end opening 12. The closed top end 9 and the sidewall 10 may have one or more knockouts 13. A knockout 13 may be punched through and removed to leave an opening in the closed top end 9 or the side wall 10, for building electrical power wires (e.g. non-metallic sheathed cable, or to receive metal flexible conduit) to be inserted through the opening. A knockout 13 may also have a smaller opening in it (e.g., a slit, slot, etc., that is smaller than the opening that results when the knockout 13 has been removed from the closed top end 9 or the side wall 10) that may allow the installer to pry-out the knockout with a flathead screwdriver. The knockout 13 may be more than ½ inch in its smallest diameter (as its shape may be elliptical as shown, having a minor diameter and a major diameter). The casing 2 may have a horizontal cross section that is shaped as a polygon. For example, the horizontal cross section of the casing 2 may be square, rectangle, pentagon, hexagon, heptagon, octagon, nonagon, or decagon. The casing 2 may be made from a flat sheet of metal that is folded into a polygonal cylinder to form the sidewall 10. The casing 2 may also be ellipsoid, frusto-conical, or otherwise curved.

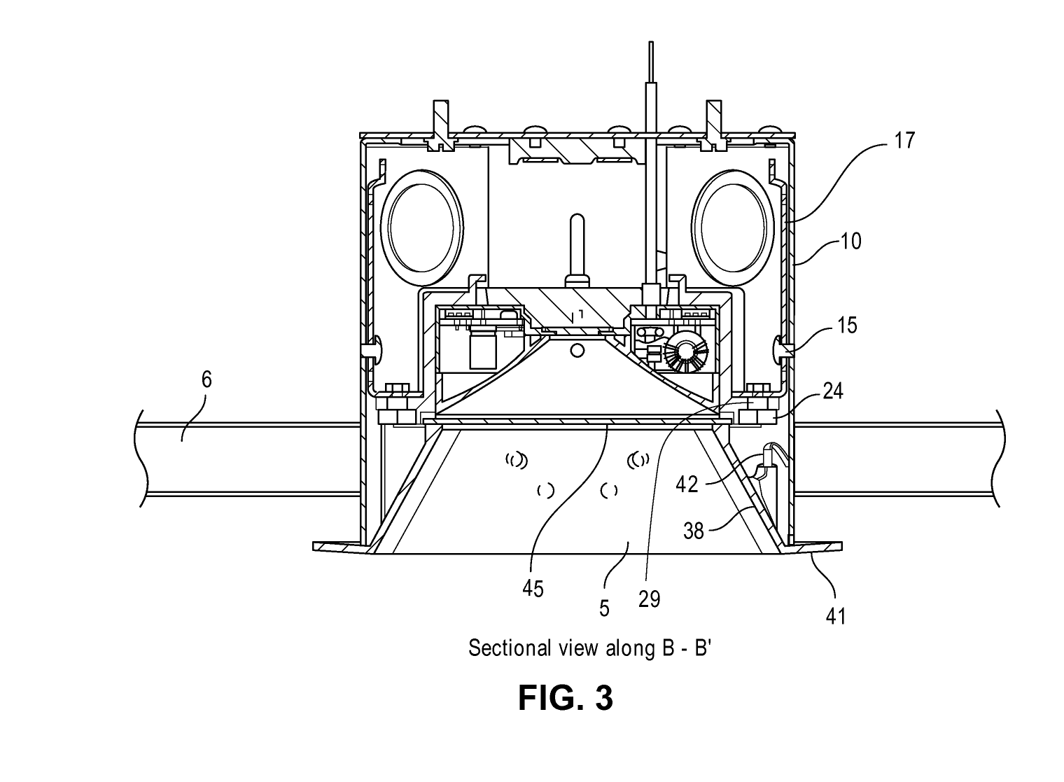

Held inside the light source cavity 11 is the light source module 4, which has a housing in which a light source 31 and a driver 32 are installed. The building electrical power wires that are routed into the casing 2 are connected to a set of driver wires that merge from the module 4, within the cavity 11. These electrical wires may be connected together through the use of interlocking connectors that may be contained within the cavity 11 of the casing 2. In other embodiments, the electrical wires may be coupled to each other through the use of electrical caps or other devices (inside the cavity 11 of the casing 2). When the wires are connected, electricity may pass from the building electrical power wiring network to the driver 32 to enable the driver 32 to power the light source 31 (and thereby illuminate the room). In one embodiment, where there is a network of such recessed lighting units 1 installed within a building, as depicted in FIG. 1B, the electrical wires that come into the casing 2 (through the knockout 13 for example) can be routed directly from their “adjacent” connection at another recessed lighting unit 2 (that may be installed behind the same ceiling or wall, or a nearby one in the same building.) In other words, the building electrical wires coming into the casing 2 (to supply power to operate the light source module) can be directly routed from the inside of another, nearby recessed lighting unit or from a shared junction box as shown in FIG. 1B. In other words, the casing 2 has two or more driver wires 33 that emerge from the light source module 4 (see FIG. 4) and that are electrically connected to the two or more building electrical power wires, respectively, inside the cavity 11 of the casing 2. This obviates the need to add a separate junction box to make such a connection, in part because the casing 2 is also fire-rated to be a protective housing for the connection between i) the driver wires that emerge from or terminate in the driver 32 and ii) the building wires that come into the casing 2 and that are directly connected to power another recessed lighting unit in the same building.

The driver 32 is an electronic circuit or device that supplies and/or regulates electrical energy to the light source 31 and thus powers the light source 31 to emit light. The driver 32 may be any type of power supply circuit, including one that delivers an alternating current (AC) or a direct current (DC) voltage to the light source 31. Upon receiving electricity, the driver 32 may regulate current or voltage to supply a stable voltage or current within the operating parameters of the light source 31. The driver 32 receives an input current from the building electrical power wiring network of the building or structure in which the recessed lighting unit 1 is installed, and may drop the voltage of the input current to an acceptable level for the light source 31 (e.g., from 120V-277V to 36V-48V).

The light source 31 may be any electro-optical device or combination of devices for emitting light. For example, the light source 31 may have one or more light emitting diodes (LEDs), organic light-emitting diode (OLEDs), or polymer light-emitting diode (PLEDs). The light source 31 receives electricity from the driver 32, as described above, such that the light source 31 can emit a controlled beam of light into a room or surrounding area of the recessed lighting unit 1 (as installed behind a ceiling or wall).

In one embodiment, the light source module 4 may also include a lens 45. The lens 45 may be formed to converge or diverge, or simply filter, the light emitted by the light source 31. The lens 45 may be a simple lens comprised of a single optical element or a compound lens comprised of an array of simple lenses (elements) with a common axis. In one embodiment, the lens 45 also provides a protective barrier for the light source 31 and shields the light source 31 from moisture or inclement weather. The lens 45 may be made of any at least partially transparent material, including glass and hard plastics, and may be sized and shaped to be snap fitted into position covering the main opening at the bottom of the module 4 as shown. In one embodiment, the lens 45, the light source 31, and the driver 32 are contained in a single indivisible unit, the light source module 4, to work in conjunction to focus and adjust light emitted by the light source 31.

The light source module 4 may, or may not, be attached to a trim 5. The trim 5 has a crown 38 (as seen in FIG. 2 and FIG. 3), also referred to here as an annular region, whose central opening 8 allows light from the light source module 4 to pass through and illuminate the room or environment beyond the wall or ceiling. A brim 41 may surround the base of the crown 38, serving to hide or cover an edge of the wall or ceiling in which a hole for emitting light into the room is formed. Although not shown, that edge may surround the sidewall of the casing 2 (once the lighting unit 1 has been installed.) The crown 38 may be frusto-conical around the opening 8, and its height (crown height 39) may be in the range of 1 inch to 2.5 inches measured vertically from a top surface of the brim 41 (that may abut the ceiling or wall) to a top of the crown 38. This may define the height of the trim 5; as mentioned above, trims of different height that are designed to be attached to the same light source module 4 and to the casing 2 can be used (interchangeably).

In one embodiment, the crown 38 may be pushed deep into the casing 2 so that the brim 41 comes into contact with (abuts or is flush against) the edge of the sidewall that defines the bottom opening 12 of the casing 2. In another embodiment, where the edge of the casing 2 might not be aligned flush with the bottom surface of the wall or ceiling (e.g., where the bottom opening 12 of the casing 2 lies above or behind of the wall or ceiling), the crown 38 is pushed into the casing 2 but cannot be as deep, even though the brim 41 is still flush with the wall or ceiling.

In one embodiment, referring now to FIG. 4, the light source module 4 as shown therein may be rigidly attached to the trim 5 via a twist and lock mechanism. One half of the twist and lock mechanism being a bump or a hook that is formed at the top (of the crown 38) of the trim 5, while the other half is a tapered portion 37 that is formed on a lip 28 of the light source module 4; the user rotates the trim 5 and the module 4 relative to each other until the bump or hook of the trim 5 is aligned with the slot that is formed in the lip 28 next to the tapered portion 37 and then pushes the two parts towards each other while “twisting” so that the bump or hook and the tapered portion 37 engage each other until they are “locked” through friction. This provides a tool-free way to couple the trim 5 to the light source module 4. Other suitable means for attaching the top of the crown 38 to the light source module 4 may be possible, including a threaded fastener (e.g., screw, or a nut and bolt combination), a snap fit mechanism, a clip, an adhesive, and clamp that clamp the lip 28 to a flat top surface of the crown 38.

Returning to FIGS. 1A, 2, 3, once the trim 5 is attached to the light source module 4, and the electrical connection between the driver wires and the building wires inside the casing 2 has been made, the assembly of the light source module 4 and the trim 5 may be pushed upwards or inward into the cavity of the casing 2, through the hole in the ceiling or wall, until the brim 41 sits flush against the ceiling or wall. This may complete the installation of the recessed lighting unit 1.

Any suitable means for attaching the assembly of the light source module 4 and trim 5 to the sidewall of the casing can be used, in order to hold the trim 5 flush against the ceiling or wall. In one embodiment, as seen in the section view of FIG. 2, one or more friction clip 42 may be utilized to secure the assembly to the casing 2, which also allows the trim 5 to slide upward along the sidewall of the casing 2 as it is pushed by the user, to eventually lie flush against the ceiling or wall. As shown in the embodiment of FIG. 2, the friction clip 42 may be attached at its anchored end (via screw, bolt, resin, glue, or the like) to the crown 38 of the trim 5, while at their flexible or resilient end they will engage the sidewall of the housing 2. Alternatively, the friction clip 42 may be anchored to the light source module 4, or to a frame 18 of the holding bracket 3 as described below. As seen in the embodiment of FIG. 2, the friction clip 42 may be composed of a generally V-shaped piece (e.g., of metal) that is oriented upside down as shown, with one segment of the V being anchored to the top surface of the frustum of the crown 38 (the bottom surface of the crown serving to reflect the light emitted from the module 4 into the room) while the other segment of the V comes into direct frictional contact with the inner surface of the sidewall 10 of the casing 2. The stiffness (when squeezing the two segments of the V towards each other) of the clip 42 provides sufficient friction that overcomes the combined weight of the light source module 4 and the trim 5, thereby preventing the assembly from falling out of the casing 2 (e.g. under the force of gravity.) Other means for attaching the light source module-trim assembly to the casing 2 include the use of one or more magnets that may be fixed on the trim 5, or on the light source module 4, and that are attracted to the casing 2 through magnetic force to hold the assembly in the casing 2, while still allowing the assembly to be slid upwards by the user (until the trim lies flush against the ceiling.)

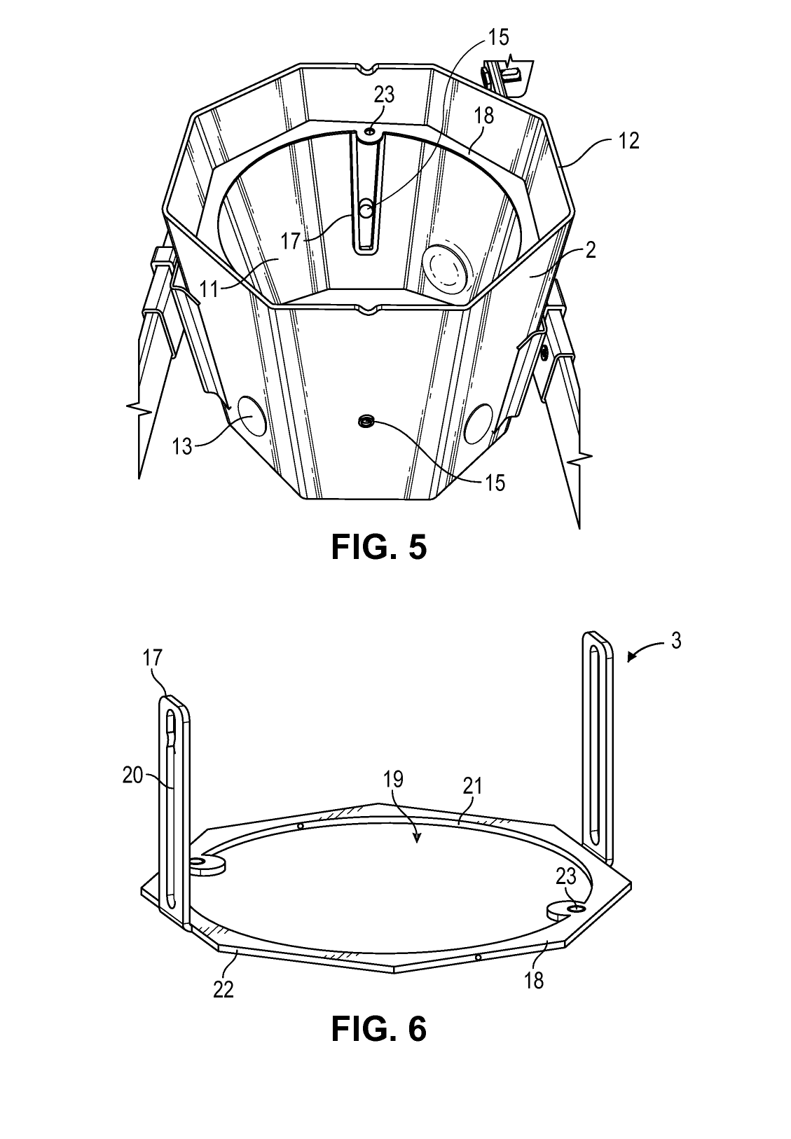

Also shown in FIGS. 1A and 1n the section view of FIG. 3 is another embodiment of the invention, where a holding bracket 3 is added inside the cavity of the casing 2. A perspective view of the holding bracket 3 is shown in FIG. 6. The holding bracket 3 may be a separate piece than the casing 2, and is coupled to an attaching member 15 that is fixed in position onto the sidewall 10. The bracket 3 may have one or more arms 17 that extend upward from a frame 18 that has a frame opening 19 therein. In a preferred embodiment, there are two arms 17 that extend upward from the frame 18, but additional arms 17 may be provided. The bracket 3 may be initially formed from a flat sheet of metal, with the frame 18 and the arms 17 formed on a same plane. Subsequently, the arms 17 may be cut out and then bent upward in the same direction. Each arm 17 may have a slot 20 running along its length through which a respective attaching member 15 may be fitted. The attaching member 15 may be a screw, bolt, pin, rivet or any other structure that is capable of coupling with the arm 17, by extending through the slot 20 and being fixed to the sidewall 10. While so engaged to the attaching member 15, the arm 17 of the bracket 3 is slidable within the cavity 11, relative to the attaching member 15 and along its slot 20. There may be some friction between the slot 20 and the attaching member 15 that may prevent the bracket 3 from freely sliding downward (under the force of gravity alone.) To maintain a desired, and optionally, adjustable, spacing between the arm 17 and the sidewall, the attaching member 15 may be threaded so as to receive a corresponding nut (not shown). In that condition, the arm 17 is held within a desired spacing between the nut and the sidewall 10 of the casing 2. In one instance, the nut is received on the end of the attaching member 15 that is located inside the casing 2.

The holding bracket 3 may also be described as having multiple arms extending upward from the frame 18, where the frame 18 has a border that encloses a frame opening 19 as shown. The slot 20 is elongated, and runs along a length dimension of its respective arm 17. The attaching member 15 extends from the sidewall 10 into the cavity 11 of the casing 2, while passing through the slot 20, and is sized so as to couple the arm 17 to the sidewall 10 constraining translation of the arm 17 in the lateral direction but allowing pivoting of the arm 17 about the attaching member 15. The arm 17 has a surface that is facing the sidewall 10 and that is flat from one end to another end that is joined to the border of the frame 18. The arm 17 is slidable along the sidewall 10 between its innermost position and its outermost position within the cavity, wherein the outermost position of the arm is reached when its sliding is stopped by the attaching member 15.

Note that use of the bracket 3 is optional. When the bracket 3 is used, its frame 18 may be attached to the light source module 4, before the trim 5 is attached to the module 4. The arms of the bracket 3 and the slots therein should be long enough to allow the bracket 3 to slide deeper into the cavity 11, as needed to raise the trim 5 so that the brim 41 can lie flush against the ceiling or wall.

In one embodiment, when the bracket 3 is at its innermost (or uppermost) position inside the cavity 11, the bottom of the frame 18 may be within the range of 1 inch to 2.5 inch above the bottom edge of the sidewall of the casing 2 (that defines the bottom end opening 12 of the casing 2.) In one embodiment, when the bracket 3 is at its outermost (or lowermost) position, the bottom of the frame 18 may be in the range of 0 inch to ½ inch below the bottom edge of the sidewall of the casing 2. Also, when the bracket 3 is at its outermost position, there may be some play allowing the bracket 3 to pivot laterally (when the attaching members 15 are up against the uppermost end of the slots 20.) The bracket 3 also functions to prevent the light source module 4 (and the attached trim 5) from falling out of the casing 2, when the bracket has reached its outermost position; the attaching member 15 in that condition acts as a stop against the sliding arm 17, by abutting an inner top end of the arm that is defined by the slot.

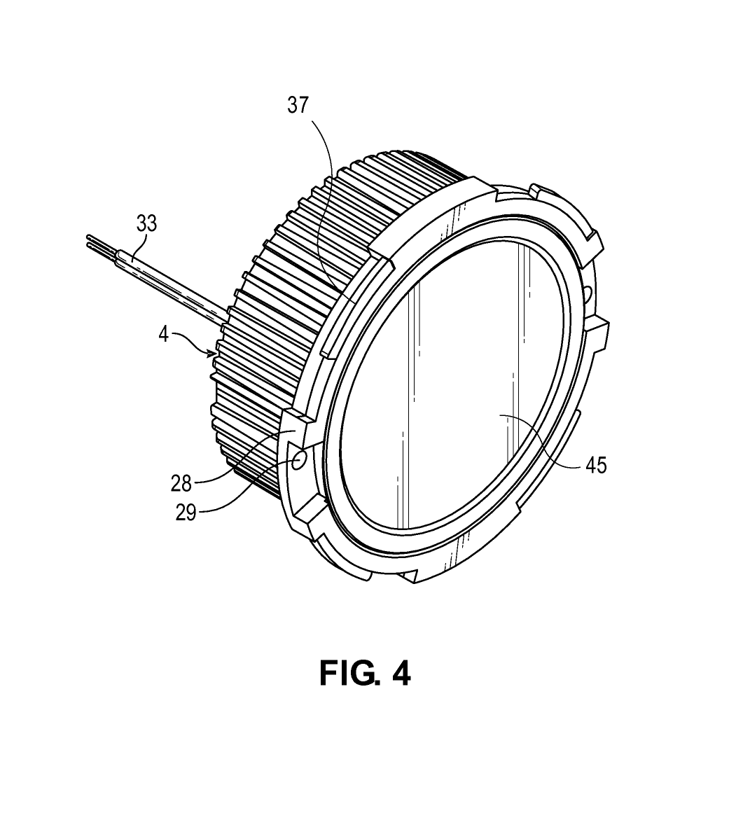

As seen in FIG. 6, the frame 18 of the holding bracket 3 may have an inner edge 21 that is circular, oval, polygonal or curved. The frame 18 may have an outer edge 22 that is circular, oval, polygonal or curved. The outer edge 22 and the inner edge 21 may have different contours. In the embodiment shown in FIG. 5 for example, the outer edge 22 is polygonal while the inner edge 21 is circular. In a preferred embodiment, the outer edge 22 has the same number of sides as the casing 2, and the outer edge 22 conforms to the shape of the sidewall 10 of the casing 2. It is not necessary to have the outer edge 22 of the frame 18 that precisely conforms to the shape of the sidewall 10 of the casing 2. In one embodiment, the outer edge 22 may be oval or circular as long as the frame 18 fits inside the cavity 11 of the casing 2.

The frame 18 is attached to the light source module 4. As also seen in FIG. 3, the frame 18 may have an opening 23 that is configured to receive a corresponding attaching member 24, such as a screw, bolt, pin, or any other fastener piece that is capable of attaching the light source module 4 to the frame 18. As seen in FIG. 4, the light source module 4 may have a lip 28 that extends laterally outward from a base of the housing of the module 4, surrounding the base where the lens 45 is fitted (and from which light produced by the light source 31 emerges to illuminate the room below). One or more openings 29 may be formed on the lip 28 that correspond to and align with the openings 23 of the frame 18, when the housing of the module 4 has been inserted through the frame opening 19 of the frame 18, as depicted in FIG. 2. Once the bottom surface of the frame 18 abuts the top surface of the lip 28, a fastener (e.g., the attaching member 24 depicted in FIG. 1A), can be inserted through both openings and then can be fastened so as to secure the module 4 to the frame 18. In the embodiment shown in FIG. 6, there are two openings 23 formed in the frame 18 which correspond and align with to the two openings 29 that are formed in the lip 28 of the light source module 4 as seen in FIG. 4; the attachment of course can also be achieved at more than locations (with more than two fasteners).

In one embodiment, the recessed lighting unit 1 may include a set of hangar bars 6 as shown in FIG. 1 from which the casing 2 can be hung. The hangar bars 6 may be rigid, elongated members that are connected between adjacent joists and/or beams that are behind the walls or ceilings of the building (there may be two, positioned on opposite sides of the casing 2 as shown). In one embodiment, each of the hangar bars 6 may be telescoping such that the hangar bar 6 can be extended or retracted to meet the gap between the joists and/or beams.

In one embodiment, each of the hangar bars 6 may include mounting blocks 46 at its ends, which are the points at which the hangar bars 6 are attached to the joists and/or beams. For example, as shown in FIG. 1A, the mounting blocks 46 may include holes for receiving screws and/or nails or other fasteners that enable the hangar bars 6 to be securely attached to a building structure. Although shown in FIG. 1A and described above in relation to holes and screws, in other embodiments, other mechanisms of attachment may be used in conjunction with the mounting blocks 46, including resins, clips, or clamps to attached the bars 6 to the building structure. In one embodiment, a mounting block 46 may be integrated in one indivisible structure along with the hangar bar 6, while in other embodiments, as shown in FIG. 1A, the mounting blocks 46 may be coupled to the hangar bars 6 through the use of one or more attachment mechanisms (e.g., screws, bolts, resins, clips, or clamps). Using the telescoping and mounting features described above, the recessed lighting unit 1 may be installed in almost all of the typical 2″×2″ through 2″×18″ wood joist constructions, metal stud constructions, and t-bar ceiling constructions.

Still referring to FIG. 1A, in one embodiment, the recessed lighting unit 1 may have a mechanism for mounting the casing 2 to the hangar bars 6, that includes a set of casing holders 7 that couple the casing 2 to the hangar bars 6. As also seen in FIG. 2, the casing holder 7 may have a plate portion that conforms to the polygonal shape of the sidewall and is secured to the sidewall 10 of the casing 2 by a nut and bolt/screw combination 49; if a slot is also formed in the sidewall 10 through which bolt/screw of the combination 49 passes, then the height of the casing 2 becomes adjustable relative to the hangar bars 6. Alternatively, the casing holder 7 may be attached to the sidewall via a clip, a clamp, a weld, or an adhesive resin. The casing holder 7 may have another portion that is configured to wrap around but slide (or otherwise move) along the length of its corresponding, elongated hangar bar 6 (between the ends of the hangar bar 6.) The casing 2 may thus be moved along the hangar bars 6 to a desired location (e.g., at which the lens 45 of the light source module 4 will be directly above the opening in the ceiling or wall), and then it may be affixed to the hangar bars 6 once at the desired location, so that the casing holder 7 can no longer be moved relative to the hangar bars 6.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, as mentioned above, the light source module 4 need not be attached to the trim 5 (such as by a twist and lock mechanism or other attachment mechanism), if the module 4 is attached to the holding bracket 3; in that case, the module 4 can simply be pushed up into the casing 2, by the user gripping the trim 5 and aligning it so that the top of the crown 38 abuts the lip 28 of the module 4, and then pushing upward (until the brim 41 of the trim 5 abuts the ceiling or wall or other building partition, at which point the friction clips 42 should have been squeezed between the crown 38 and the sidewall 10 (thereby securing the trim 5 to the casing 2.) The description is thus to be regarded as illustrative instead of limiting.

What is claimed is:

1. A recessed lighting unit comprising:
a casing having a closed top end, a side wall having a top edge that joins the closed top end, wherein the side wall extends downward from the closed top end and is curved so as to completely surround a cavity that is between the closed top end and an open bottom end of the casing that is defined by a bottom edge of the sidewall, wherein a plurality of building electrical power wires are to be routed directly from a casing of another recessed lighting unit or directly from a wire enclosure, into the casing without passing through a junction box that is dedicated to the recessed lighting unit;
a light source module having a plurality of driver wires that are to be electrically connected to the plurality of building electrical power wires, respectively, inside the cavity of the casing;
a trim having a crown that has a frusto-conical shape, wherein the crown has a base with a base opening formed therein, a top with a top opening formed therein, wherein light to be emitted from the source module is to pass through the crown by passing through the top opening and then through the base opening before illuminating a room, and a frustum that extends from the base to the top, and a brim that is attached to the base and encircles the base opening; and
means anchored to the frustum of the crown for attaching to the sidewall of the casing.

2. The recessed lighting unit of claim 1 further comprising means for attaching the trim to the light source module.

3. The recessed lighting unit of claim 2 wherein the means for attaching the trim to the light source module comprises a twist and lock mechanism formed on a lip of the light source module and on a top of the crown of the trim.

4. The recessed lighting unit of claim 1 wherein the closed top end or sidewall of the casing has a knockout that is to be opened to reveal a hole, through which the building electrical power wiring is routed into the casing.

5. The recessed lighting unit of claim 1 wherein the crown has a height, as measured vertically from a top flat surface of the brim to a top of the crown that abuts the light source module, that is in the range of 0.5 inch to 2 inches.

6. The recessed lighting unit of claim 1 wherein the sidewall of the casing has a horizontal cross section that is shaped as a polygon.

7. The recessed lighting unit of claim 6 wherein the casing is folded into shape from a flat sheet of metal.

8. The recessed lighting unit of claim 7, wherein the metal is galvanized steel.

9. The recessed lighting unit of claim 1 wherein the casing has a plurality of knockouts formed therein any one of which is to be used for bringing building electrical power wires, that are directly connected to another recessed lighting unit in the building without passing through a junction box, into the casing, to power the light source module in the casing.

10. The recessed lighting unit of claim 1 wherein means for attaching to the sidewall of the casing comprises a plurality of friction clips anchored to the crown.

11. The recessed lighting unit of claim 1 further comprising:
a holding bracket having a plurality of arms extending upward from a frame, wherein the frame has a border that surrounds an opening through which the light source module extends;
a slot running along a length of each of the plurality of arms; and
a plurality of attaching members positioned on the side wall of the casing, each attaching member extending into the cavity of the casing and passing through the slot of one of the plurality of arms to couple said one of the plurality of arms to the sidewall, wherein the arm is to slide relative to the attaching member along its.

12. The recessed lighting unit of claim 11 wherein a lip of the light source module is attached to the border of the frame of the holding bracket.

13. A recessed lighting unit comprising:
a casing having a side wall that surrounds a cavity and defines a bottom end opening;
a holding bracket having a plurality of arms extending upward from a frame that defines a frame opening;
a slot running along a length of each of the plurality of arms; and
a plurality of attaching members positioned on the side wall of the casing, each attaching member extending into the cavity of the casing and passing through the slot of one of the plurality of arms to couple the one of the plurality of arms to the side wall, wherein the holding bracket is slidable within the cavity along the slots of the plurality of arms.

14. The recessed lighting unit of claim 13, wherein the casing has a horizontal cross section that is shaped as a polygon.

15. The recessed lighting unit of claim 14, wherein the polygon is a pentagon, hexagon, heptagon, octagon, nonagon, or decagon.

16. The recessed lighting unit of claim 15, wherein the frame has a polygonal outer edge that has the same number of sides as the horizontal cross section of the casing.

17. The recessed lighting unit of claim 13, wherein the casing is folded into shape from a flat sheet of metal.

18. The recessed lighting unit of claim 17, wherein the metal is galvanized steel.

19. The recessed lighting unit of claim 13, wherein each of the attaching members comprises a threaded pin, the lighting unit further comprising:
a plurality of nuts, each coupled to the threaded pin of a corresponding attaching member so that the arm of the holding bracket is held between the nut and a sidewall of the casing.

20. The recessed lighting unit of claim 13, wherein the frame is positioned entirely inside of the casing when the holding bracket has been slid to an innermost position within the cavity.

21. The recessed lighting unit of claim 20, wherein the frame is positioned entirely outside of the casing when the holding bracket has been slid to an outermost position, wherein the outermost position is when the attaching member abuts an inner top end of the arm that is defined by the slot.

22. The recessed lighting unit of claim 21, further comprising:
a light source module having a base opening from which light is emitted by the module to illuminate a room, a housing extending longitudinally rearward from the base opening, and a lip extending laterally outward from the base opening,
wherein the light source module is coupled to a bottom surface of the frame along the lip, while a portion of the housing of the light source module fits through the frame opening of the frame.

23. The recessed lighting unit of claim 22, further comprising:
a trim having an annular region through a central opening of which light from the light source module is to pass through for illuminating the room;
means for attaching the trim to the light source module; and
means for attaching the annular region to the sidewall of the casing.

24. The recessed lighting unit of claim 13, further comprising:
a plurality of hangar bars positioned outside of the casing and coupled to the casing.

25. A recessed lighting unit network comprising:
first and second recessed lighting units, wherein each has i) a fire-resistant casing having a sidewall that completely surrounds a cavity therein, wherein the cavity is defined between a closed top end and an open bottom end of the casing, ii) a light source module having a plurality of driver wires that emerge from the module, a trim that is attached to the light source module, and iii) means for attaching the trim to a sidewall of the casing,
wherein a plurality of building electrical power wires are routed into the casing of the first recessed lighting unit where they are electrically connected to the driver wires inside the cavity of the casing,
and wherein the plurality of building electrical power wires are also routed directly from the casing of the first recessed lighting unit into the casing of the second recessed lighting unit without passing through a junction box, and are electrically connected to the driver wires inside the cavity of the casing of the second recessed lighting unit.

26. The recessed lighting unit network of claim 25 wherein the first recessed lighting unit further comprises:
a holding bracket having a plurality of arms extending upward from a frame having a border that encloses a frame opening;
an elongated slot running along a length of each of the plurality of arms; and
a plurality of attaching members positioned on the side wall of the casing, each attaching member extending into the cavity of the casing and passing through the slot of a respective one of the plurality of arms, to couple the respective arm to the side wall, wherein the respective arm has a surface facing the sidewall that is flat from one end to another end that is joined to the border of the frame, and wherein the respective arm is slidable along the sidewall between an innermost position and an outermost position within the cavity, wherein the outermost position is reached when the sliding respective arm is stopped by the attaching member.

27. The recessed lighting unit network of claim 25 wherein the first recessed lighting unit further comprises means for attaching the light source module to the trim.
